(19) United States
(12) Patent Application Publication
(10) Pub. No.: US 2004/0221871 A1
(43) Pub. Date: Nov. 11, 2004

(54) Semiconductor wafer processing apparatus and method therefor

(76) Inventors: Matthew F. Fletcher, Austin, TX (US); Lesley A. Smith, Austin, TX (US); Olivier G. Vatel, Round Rock, TX (US); Olubunmi O. Adetutu, Austin, TX (US)

Correspondence Address: FREESCALE SEMICONDUCTOR, INC., LAW DEPARTMENT, 7700 WEST PARMER LANE MD:TX32/PL02, AUSTIN, TX, 78729, US

(21) Appl. No.: 10/431,033

(22) Filed: May 7, 2003

(51) Int. Cl. B08B 7/04; B08B 7/00

(52) U.S. Cl. 134/6; 134/18; 134/21; 134/26; 134/30; 134/32; 134/34; 134/37; 118/712; 118/72; 118/50.1

(57) ABSTRACT

A semiconductor wafer processing apparatus (10) includes a front-end robot (28), a wafer scrubber/dryer (30), a moisture detector (34) and a load/lock chamber (38, 40). The front-end robot (28) moves a wafer to be processed between the wafer cassette (21-24), the wafer scrubber (30), the moisture detector (34) and the load/lock chamber (38, 40). Optionally, the load/lock chamber (38, 40) may include an additional moisture detector. The load/lock chamber (38, 40) functions as an interface to a vacuum processing chamber (50, 52, 54) for performing various deposition processing steps where introduction of moisture would be destructive to the wafer.

### FIELD OF THE INVENTION

The present invention relates generally to semiconductor manufacturing, and more particularly, to an automated semiconductor wafer processing apparatus and method therefor.

### BACKGROUND OF THE INVENTION

Semiconductor wafer processing requires the use of various types of processing equipment in a clean room environment. Prior to introducing a wafer to a particular processing chamber, the wafer may be cleaned and/or scrubbed to remove residual chemicals and particles from the wafer due to previous processing steps or from the environment. Currently, separate scrubbers are used where necessary in the process flow. After scrubbing, wafers are removed from the scrubber to the next tool for further processing, such as for metal deposition and dielectric deposition. However, keeping the wafer clean between processing steps can be difficult. The wafer may be exposed to contaminants while waiting to be processed, even though the processing equipment may be in a “clean room”, thus reducing production yields.

Mini environments have been used to keep the wafers clean between processing steps. For example, systems such as FOUP (front opening unified pod), SMIF (standard mechanical interface) pods, and the like, have been used to reduce the effects of environmental defectivity. However, these systems do not have the ability to remove defectivity from prior process steps. Also, the use of these systems still does not preclude additional handling steps in to the overall manufacturing process, complicating wafer lot tracking.

Therefore there is a need for a semiconductor wafer processing apparatus that increases yield, reduces wafer handling, and improves cycle time.

### BRIEF DESCRIPTION OF THE DRAWINGS

FIG. 1 illustrates a top down view of a semiconductor wafer processing apparatus in accordance with the present invention.

FIG. 2 illustrates a more detailed view of the load/lock chamber of FIG. 1.

FIG. 3 illustrates a more detailed view of the moisture detector of FIG. 1.

FIG. 4 illustrates, in flow chart form, a method for processing a wafer in accordance with the present invention.

### DETAILED DESCRIPTION

Generally, the present invention provides a semiconductor wafer processing apparatus that includes a front-end robot, a wafer scrubber, a moisture detector and a load/lock chamber. The front-end robot moves a wafer to be processed between the wafer cassette, the wafer scrubber, the moisture detector and the load/lock chamber. Also, wafer defectivity metrology may be included. In addition, the load/lock chamber may include a moisture detector for providing additional security against introducing moisture into the rest of apparatus 10. The load/lock chamber may function as an interface to a vacuum processing chamber for performing various deposition processing steps where introduction of moisture would be destructive to the wafer.

The semiconductor wafer processing apparatus provides the advantages of improved yields because the number of manual handling steps is reduced with less exposure to possible environmental contamination. In addition, reducing the number of wafer handling steps improves cycle time and wafer tracking operations.

FIG. 1 illustrates a top down view of a semiconductor wafer processing apparatus 10 in accordance with the present invention. Apparatus 10 includes wafer cassette station 12, front-end handler/scrubber module 14, load/lock module 16, process tool 18, and control system 20. Wafer cassette station 12 includes wafer cassettes 21, 22, 23, and 24. Each of these cassettes may support from 1 to 25, or more, individual wafers. Front-end handler/scrubber module 14 includes front-end robot 28, scrubber 30, gas curtain 32, moisture detector 34, and optionally, defectivity metrology 35. Front-end robot 28 has a robot arm 80 for supporting a wafer. Load/lock module 16 includes load/lock chambers 38 and 40 and moisture detector 42. Load/lock chamber 38 includes doors 37 and 39 and load/lock chamber 40 includes doors 41 and 43. Process tool 18 includes buffer chamber 48, robot 46, vacuum processing chambers 50, 52, and 54. Vacuum processing chamber 50 has doors 56, vacuum processing chamber 52 has doors 58, and vacuum processing chamber 54 has doors 60. Control system 20 is used to control the operation of apparatus 10 and is electrically coupled to each of the various functions of apparatus 10 via interface units 36, 44, and 62. However, in another embodiment, units 36, 44, and 62 may be control units that coordinate operations via control system 20.

In operation, front-end robot 28 removes a wafer from one of the wafer cassettes 21, 22, 23, and 24 and moves the wafer to scrubber 30. Front-end robot 28 is free to move along the wafer cassettes as indicated by the two arrows. A scrubbing process using water and/or a wafer scrubbing chemical is used in the scrubbing process. In another embodiment, another type of cleaning tool may be used in place of scrubber/dryer 30. After scrubbing, scrubber 30 dries the wafer. Front-end robot 28 removes the wafer from scrubber 30 and passes the wafer through gas curtain 34. Gas curtain 34 functions as a moisture isolation barrier between the scrubber and the rest of apparatus 10 and also completes the drying process of the wafer if necessary. The gas curtain includes at least one nozzle for spraying a gas, such as for example, a forming gas (N₂/H₂) in the wafer transport path. Front-end robot 28 then moves the wafer to the moisture detector 34. Preferrably, moisture detector 34 is a Fourier transform infrared spectrometer (FTIR), or the like. However, in other embodiments, moisture detector 34 may be an optical emission spectrometerscopy (OES) or a residual gas analyser (RGA). If the wafer is detected to be dry, front-end robot 28 moves the wafer to one of door 37 of load/lock chamber 38, door 41 of load/lock chamber 40, or to defectivity metrology 35. Defectivity metrology 35 is optional and detects defects on a wafer by using one of laser light scattering, optical image comparison, and electron microscopy, or the like.

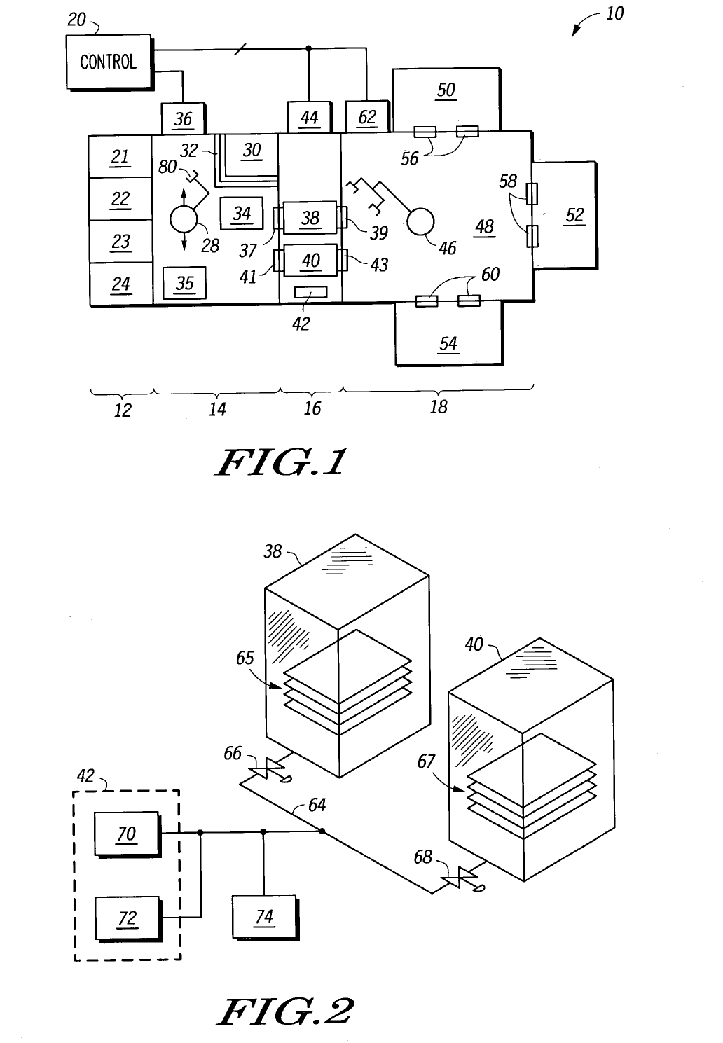

Load/lock chambers 38 and 40 are used to transfer the wafer to the vacuum of buffer chamber 48. In addition, load/lock module 16 includes additional moisture detectors 42 that will be discussed later in connection with the description of FIG. 2. Once a vacuum exists in the load/lock chamber, dual arm robot 46 removes the wafer(s) via the corresponding doors 39 or 43 and places the wafer in one of vacuum processing chambers 50, 52, or 54. Note that in the illustrated embodiment, vacuum processing chambers 50, 52, and 54 each have two doors because they process two wafers simultaneously, however, in other embodiments, vacuum processing chambers 50, 52, and 54 may process only one wafer, or more than two wafers simultaneously. The vacuum processing chambers may be used for chemical vapor deposition (CVD), physical vapor deposition (PVD), atomic layer deposition (ALD), or any process where moisture is detrimental. In addition, vacuum processing chambers 50, 52, and 54 may be a furnace processing chamber.

FIG.2 illustrates a more detailed view of the load/lock chambers 38 and 40 of FIG. 1. Note that load/lock doors 37, 38, 41, and 43 are not shown in FIG. 2. Load/lock chambers 38 and 40 are coupled via tubing 64 to moisture detector 42. As illustrated, load/lock chamber 38 includes one or more wafer platforms 65 and load/lock chamber 40 includes one or more wafer platforms 67. A vacuum pump 74 is used to pull a vacuum on load/lock chambers 38 and 40. Chamber 38 may be isolated from vacuum pump 74 using value 66. Chamber 40 may be isolated from vacuum pump 74 using value 68. Values 66 and 68 are generally only closed when the chambers need to be opened to the atmosphere. In the illustrated embodiment, moisture detector 42 includes two moisture detectors 70 and 72 coupled to both chambers using vacuum tube 64. Moisture detector 70 employs optical emissions spectroscopy (OES) to detect moisture and moisture detector 72 uses residual gas detector (RGA) to detect moisture. In other embodiments, the moisture detectors may be attached to, or included in, the chambers. Also, different types of moisture detectors may be used such as an FTIR moisture detector.

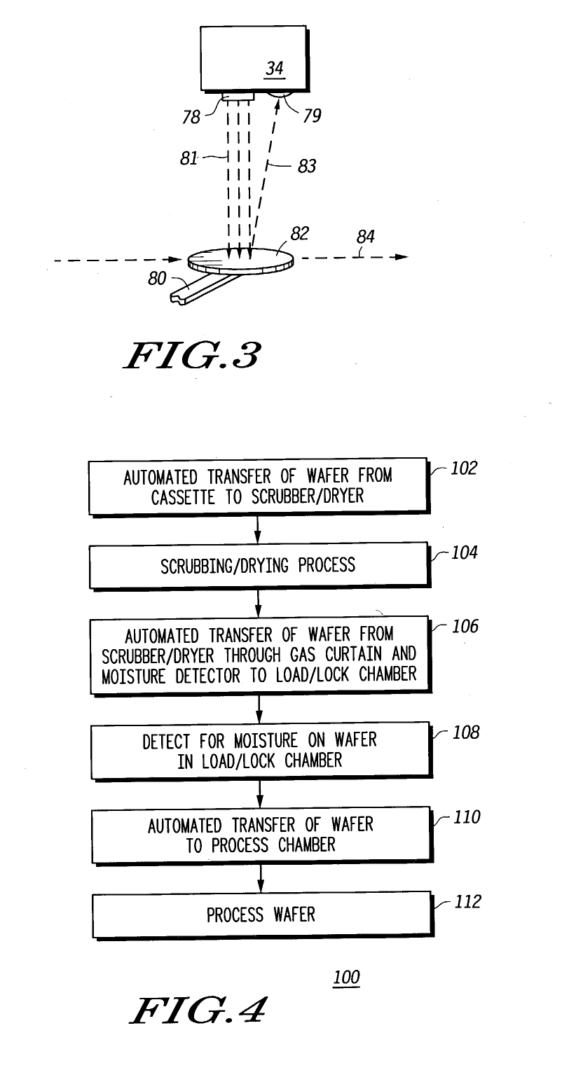

FIG. 3 illustrates a more detailed view of the FTIR moisture detector 34 of FIG. 1. FTIR Moisture detector 34 includes an infrared (IR) source 78 and IR sensor 79. As a wafer 82 is supported by robot arm 80 and transported along a wafer transport path 84. IR light is emitted from IR source 78 creating an IR detection field 81. As wafer 82 moves through IR field 81, the reflected IR light 83 from wafer 82 is sensed by sensor 79 to determine if the wafer is dry.

FIG. 4 illustrates, in flow chart form, a method 100 for processing a wafer in accordance with the present invention. At step 102, the wafer is automatically transferred from the wafer cassette station 12 to scrubber/dryer 30. At step 104, the wafer is scrubbed and then dried by scrubber/dryer 30. At step 106, the wafer is automatically transferred from scrubber/dryer 30 through gas curtain 32, and moisture detector 34 to load/lock chamber 38 or 40. At step 108, moisture detector 42 is used to detect moisture on the wafer in load/lock chamber 38 or load/lock chamber 40. At step 110, the wafer is then automatically transported to vacuum process chamber 18, and at step 112, the wafer is processed.

As described above, semiconductor wafer processing apparatus 10 provides the advantages of improved yields because the number of manual handling steps is reduced with less exposure to possible environmental contamination. In addition, reducing the number of wafer handling steps improves cycle time and wafer tracking operations.

While the invention has been described in the context of a preferred embodiment, it will be apparent to those skilled in the art that the present invention may be modified in numerous ways and may assume many embodiments other than that specifically set out and described above. Accordingly, it is intended by the appended claims to cover all modifications of the invention which fall within the true scope of the invention.

What is claimed is:

1. A wafer processing apparatus comprising:
a wafer cleaning tool;
a vacuum process chamber; and
an automated wafer transport path from the wafer cleaning tool to the vacuum process chamber.

2. The wafer processing apparatus of claim 1 further comprising:
a moisture detector positioned to detect moisture on a wafer in at least one location along the automated wafer transport path.

3. The wafer processing apparatus of claim 2 wherein:
the moisture detector generates a detection field, the automated wafer transport path extending through the detection field.

4. The wafer processing apparatus of claim 3 wherein the moisture detector includes an infrared source for generating the detection field and an infrared sensor.

5. The wafer processing apparatus of claim 2 further comprising:
a load chamber, the automated wafer transport path extending through the load chamber, wherein the moisture detector is coupled to the chamber to detect moisture in the chamber.

6. The wafer processing apparatus of claim 5 further comprising:
a tube coupled to the load chamber to remove air for generating a vacuum in the load chamber; and
wherein the moisture detector is coupled to the chamber via the tube to detect moisture in the chamber via the tube.

7. The wafer processing apparatus of claim 6 wherein the tube is coupled to a vacuum pump, the vacuum pump for generating a vacuum in the load chamber.

8. The wafer processing apparatus of claim 2 wherein the moisture detector includes a residual gas analyzer.

9. The wafer processing apparatus of claim 2 wherein the moisture detector includes an optical emission spectrometer.

10. The wafer processing apparatus of claim 2 wherein the moisture detector includes an infrared source and infrared sensor.

11. The wafer processing apparatus of claim 1 further comprising:
a controller communicatively coupled to the moisture detector, the system providing an indication of moisture on a wafer in response to receiving an indication from the moisture detector indicating a detection of moisture by the moisture detector.

12. The wafer processing apparatus of claim 1 wherein the gas curtain functions as a moisture isolation barrier between the scrubber and the rest of apparatus.

13. The wafer processing apparatus of claim 12 wherein the gas curtain includes at least one nozzle, the automated wafer transport path extending through the gas curtain.

14. The wafer processing apparatus of claim 1 wherein the vacuum processing chamber is one of a chemical vapor deposition (CVD) processing chamber, a physical vapor deposition (PVD) processing chamber, an atomic layer deposition (ALD) processing chamber, and a furnace processing chamber.

15. The wafer processing apparatus of claim 1 further comprising:
a robot positioned to remove a wafer from the wafer cleaning tool and to move the wafer at least along a portion of the automated wafer transport path.

16. The wafer processing apparatus of claim 1 further comprising:
a defect metrology device, the automated wafer transport path including a portion extending from the cleaning tool to the defect metrology device for detecting defects on a wafer.

17. The wafer processing apparatus of claim 16 further wherein the defect metrology device includes one of a laser light scattering device, an optical image comparison device, and an electron microscope device.

18. The wafer processing apparatus of claim 1 wherein the wafer cleaning tool and the vacuum deposition chamber are physically coupled together.

19. The wafer processing apparatus of claim 1 wherein the vacuum processing chamber is a dry processing chamber.

20. The wafer processing apparatus of claim 1 wherein the wafer cleaning tool includes a wafer scrubber.

21. The wafer processing apparatus of claim 1 wherein the wafer cleaning tool utilizes a liquid to clean a wafer.

22. A method for processing a wafer comprising:
processing a wafer with a wafer cleaning tool;
moving the wafer from the wafer cleaning tool to a vacuum processing chamber along an automated wafer transport path to a vacuum processing chamber; and
processing the wafer in the vacuum processing chamber.

23. The method of claim 22 wherein the moving the wafer further comprises:
detecting for the presence of moisture on the wafer.

24. The method of claim 23 wherein:
the moving the wafer further includes moving the wafer into a load chamber prior to moving the wafer into the vacuum process chamber; and
the detecting for the presence of moisture on the wafer further includes detecting for the presence of moisture in the air of the load chamber.

25. The method of claim 24 wherein:
the detecting for the presence of moisture in the air of the load chamber further includes detecting for the presence of moisture in air being removed from the load chamber to generate a vacuum in the load chamber.

26. The method of claim 23 wherein
the detecting further includes generating a moisture detection field;
wherein the moving the wafer includes positioning at least a portion of the wafer in the moisture detection field.

27. The method of claim 26 wherein:
the moisture detection field is an infrared detection field;
wherein the detecting the presence of moisture further includes sensing infrared waves reflected from the wafer.

28. The method of claim 22 wherein the moving the wafer further comprises moving the wafer through a gas curtain.

29. The method of claim 22 wherein the processing the wafer in the vacuum processing chamber further includes performing on the wafer one of chemical vapor deposition (CVD) processing, physical vapor deposition (PVD) processing, atomic layer deposition (ALD) processing, and a furnace processing.

30. The method of claim 22 further comprising:
detecting for the presence of defects on the wafer after the wafer has been moved from the wafer cleaning tool but prior to the wafer being provided to the vacuum processing chamber.

31. The method of claim 22 wherein the wafer cleaning tool includes a wafer scrubber.

32. The method of claim 22 further comprising:
providing an indication to a controller of the detection of moisture in response to detecting the presence of moisture.

33. The method of claim 22 further comprising:
stopping the moving the wafer from the wafer cleaning tool to a vacuum processing chamber in response to detecting the presence of moisture.

34. A wafer processing apparatus comprising:
a wafer scrubber;
a wafer deposition chamber, the wafer deposition chamber physically coupled to the wafer scrubber;
an automated wafer transport path from the wafer scrubber to the deposition chamber, wherein the automated wafer transport path extends through at least one environmentally controlled area; and
a moisture detector positioned to detect moisture on a wafer in at least one location along the automated wafer transport path.
